(19) United States
(12) Patent Application Publication
(10) Pub. No.: US 2008/0217145 A1
(43) Pub. Date: Sep. 11, 2008

(54) Energy Switch Concept

(76) Inventor: Anne Elizabeth Kanno, Garland, TX (US)

Correspondence Address: Anne Kanno, 509 Fairway Lakes Dr., Garland, TX, 75044, US

(21) Appl. No.: 11/682,315

(22) Filed: Mar. 6, 2007

(51) Int. Cl. H01H 9/00

(52) U.S. Cl. 200/1 R

(57) ABSTRACT

The Energy Switch works similar to a light switch. It is on the wall of a room for example, and the electricity that supplies outlets with energy, can be switched off when appliances are not being used so that energy won't be wasted unnecessarily.

### BACKGROUND INFORMATION

One of my passions is to help people live comfortably in their homes. I have a concept called “The Joyful Home Concept” which is about designing, building and living in the home in a new way. Building “green,” or energy efficiently, is a standard in these new homes.

I am new to Austin, Tex., probably the top city in our country that educates architects, builders and the general public how to build “green” and how to save money by being energy efficient. In fact staff from Austin Energy's Green Building Program travel to various cities across the nation to teach others how to start Green Building Programs in their area. Recently I went to a Green by Design workshop hosted by Austin energy in Austin, Tex. There Rich McMath, an architect with Austin Energy, shared with the audience that 40% of the annual energy cost (a typical electric bill) is due to what I believe he termed, residual energy. What this means is that when a light, an oven, washer, dryer, tv or computer, for example, is turned off, but still plugged in, energy is consumed. A significant amount of a homeowners or business owners electric bills is due to this kind of energy waste. This is a huge amount of waste.

When I heard this, I thought why not make one or more switches on the wall of a room, like a light switch, that will cut off the electricity, so that this kind of waste does not persist.

### SPECIFICATIONS

### What is the Energy Switch?

It's a switch, most likely placed on a wall, that is designed to cut off electrical energy for some or all of the electrical outlets within a room or particular area so when the space is not in use, a flick of the switch will cut off the energy supply.

### Why the Energy Switch?

A significant amount of energy is lost through electrical outlets when appliances are in the “off” mode and are still plugged into the outlets. For example an oven, a ceiling fan, a t.v., chandelier, cell phone charger, or a washer and dryer that is plugged into an energy source, or outlet, but is not in use, consumes energy.

We could say that people could unplug items that are not in use, but it's not practical to unplug an oven, washer and dryer or lighting for example. An appliance like a t.v. is not easily able to be unplugged either, and small items like a cell phone charger can be a hassle to unplug.

### How Does the Energy Switch Work?

Within a room, or perhaps a group of rooms or an outdoor living area for example, all outlets or certain outlets will be chosen to be connected to an Energy Switch so that when the room or area is not in use, and the appliances will not be in use, a person can easily flip the switch to the “off” position. Upon returning to the space, one can turn on the switch to allow electricity to once again flow.

One room may have more than one Energy Switch. For example, a kitchen may have an Energy Switch on the wall near an electric oven or stove, so that when a person wants to use those particular appliances, one can turn that switch on, and when finished, can turn it off. Another Energy Switch might control the kitchen lights and other outlets in that room for things like small kitchen appliances.

### Benefits of Using the Energy Switch:

Energy bills for businesses, homeowners, organizations and the government will be reduced, if not drastically reduced.
People will become more conscious about taking care of the earth's resources, which will improve the environment.
Builders and architects will be motivated to adopt “green” building practices. (“Green” building practices are energy efficient methods and technologies that are integrated into the architectural structure and its surroundings.) The Energy Switch will help make green building practices and building with integrity become mainstream.

### Issues, Concerns and Answers:

People will not want to cut some appliances from energy supply, like a refrigerator, security system, air conditioner or a timed sprinkler system for example. This is appropriate and will be taken into consideration when mapping the area as to which outlets will be connected to the Energy Switch and which ones won't be connected to an Energy Switch.
Not all outlets are of the same voltage. Again, no problem. The outlets will be mapped to the appropriate energy switch.
Many appliances that are not in “use” have built-in clocks that are in “use” for example. Turning off the energy supply to these outlets will cause frustration and inconvenience. The amount of energy that can be saved by using the Energy Switch is too important to disregard due to clock issues, so I will educate manufacturers to produce appliances that will take the Energy Switch into consideration. Making design changes will also motivate manufactures to design and produce products that are as energy efficient and as convenient as possible.

### Placement of the Energy Switch:

The Energy Switch could be placed near individual outlets, or as a feature as part of an outlet itself, however, at this time I feel it would be more convenient if it's located near a light switch or in a convenient spot near a particular appliance for these reasons: outlets are often, and rightly so, placed in “hidden” spots for aesthetics, like behind a t.v. or even in non visible locations like behind ceiling lighting and washer and dryers for example. And if it's inconvenient to even unplug a simple appliance from the wall like a cell phone charger, people most likely won't want to bend down to flip a switch on or near the outlet itself. The placement of the Energy Switch will vary, and architects and designers can use their creativity to choose locations so that the energy switch would be most convenient for users. I imagine most of them will be located near light switches.

### Design of the Energy Switch:

I think the design of the switch can be fun, and also people won't feel confused if the are turning on a light switch or Energy Switch. It also may bring awareness and a smile to people who use this energy efficient concept. The design may be two round buttons in the shape of the infinity symbol. One button might be pressed for the “on” feature and another button for the “off position.” I can give some design suggestions to companies who produce switches.

1. I, Anne Kanno, claim the rights to the Energy Switch Concept which is a switch, button or some type of similar apparatus designed with the purpose to cut off energy flow to an outlet, some outlets or all of the outlets in a particular room, or set of rooms, or space in a home or other architectural structure that is placed there for the purpose of energy efficiency so that for appliances that are not being used and which are still plugged into outlets there will not be unnecessary energy loss.
